(19) United States
(12) Patent Application Publication
(10) Pub. No.: US 2014/0025626 A1
(43) Pub. Date: Jan. 23, 2014

(54) METHOD OF USING SEARCH ENGINE FACET INDEXES TO ENABLE SEARCH-ENHANCED BUSINESS INTELLIGENCE ANALYSIS

(71) Applicant: Avalon Consulting, LLC, (US)

(72) Inventors: Sam Mefford, Highland, UT (US); Casey Green, Frisco, TX (US); Tom Reidy, McKinney, TX (US)

(73) Assignee: Avalon Consulting, LLC, Plano, TX (US)

(21) Appl. No.: 13/866,880

(22) Filed: Apr. 19, 2013

Related U.S. Application Data
(60) Provisional application No. 61/635,460, filed on Apr. 19, 2012.

(51) Int. Cl. G06F 17/30

(52) U.S. Cl. CPC G06F 17/30864
USPC 707/603; 707/706

(57) ABSTRACT

A query technique and interactive tool for analyzing unstructured data and structured data together through an easy-to-use interface. The query technique uses field indexes within a search engine to enable fast response times, scalability across large data sets, and availability to large audiences. This invention enables embodiments to combine the best features from search experiences with the best features from business intelligence experiences. A preferred embodiment of this technique enables all features to be fully composable so that one request includes structured data analysis features including multi-column grouping and aggregations as well as unstructured data analysis features including search term stemming and dynamic summaries.

### CLAIM OF PRIORITY

This application claims priority of U.S. Provisional Patent Application Ser. No. 61/635,460 filed Apr. 19, 2012 entitled “Using a Search Engine Facet Index to Perform Joins, Groupings and Other Common Database Operations”, the teaching of which are included herein by reference.

### BACKGROUND

Increased access to data and decreased storage and computation costs have fueled a revolution in processing and analyzing large volumes of data. As organizations increasingly find value in combining and cross-analyzing disparate data sets, including both structured data (rows and columns) and unstructured data (free-form text) and everything in between, demand is growing for tools to facilitate such analysis. Many tools offer powerful features such as:

interactive analysis of terabytes of data

drag-n-drop report building

integrated full-featured search

unified analysis of unstructured and structured data sets

However, most tools only offer a sub-set of these features, because they rely upon one of three distinct methods:

The first method is to build on structured databases. Unstructured data is excluded unless it can be processed to produce something structured. Examples of structuring unstructured data include content extraction, entity extraction, enrichment with linked data related to extracted entities, categorization, and other forms of text analytics or machine learning. When structured, the data can be indexed in a database with online analytical processing (OLAP) functionality which can enable traditional business intelligence applications with interactive analysis and drag-n-drop report building. If the data set is too large for a traditional OLAP database, many modern alternative databases offer comparable functionality with improved horizontal scalability. Neither established OLAP databases nor modern OLAP databases offer full-featured search or unified analysis of unstructured and structured data sets.

The second method is to build parallel systems on a structured database and a search engine. The database enables structured data analysis (e.g. business intelligence applications) while the search engine enables unstructured data analysis. While the parallel systems separately provide structured data analysis and unstructured data analysis, this method faces significant limitations. Such a system cannot, for example, given a large database of products and sales data, provide a response to a request which requires both search and aggregation such as: show the total sales by region of products with the words “laptop OR netbook” in the name. While applications can combine small result sets from the parallel systems, such techniques cannot be applied to large result sets without significant performance penalties because the speed of databases and search engines depends on filtering result sets within the engine using indexes. In the case of a parallel database and search engine, neither contains the index of the other, so neither engine can fully filter a result set within the engine using indexes.

The third method is to build on a batch-mode processing system such as Apache Hadoop. This allows developers to write custom code which is distributed and processed across many servers. The benefit of such systems is that custom code can theoretically match all the functionality of databases or search engines. The drawback of such systems is that they require custom code, and custom-building database or search engine functionality is not easy. Even if all the required code exists for unified analysis of unstructured and structured data sets, Apache Hadoop runs map-reduce processes in batch mode—meaning response times are not fast enough to enable interactive analysis. Interactive queries and responses are required to enable drag-n-drop report building and a full-featured search experience, so those features are also lost in a system which is built on Apache Hadoop.

Many solutions have demonstrated the addition of some structured data analysis features to search engines, including those offered by Attivio, Endeca, MarkLogic, and the Solr project. However, the functionality offered is very limited compared to dedicated business intelligence solutions. These solutions do not offer one tool with interactive analysis of terabytes of data, drag-n-drop report building, full-featured search, and unified analysis of unstructured and structured data sets.

### BRIEF DESCRIPTION OF THE DRAWINGS

FIG. 1 shows a Faceted Search Application;

FIG. 2 shows a Report Builder Application;

FIG. 3 shows a Visualizations Application;

FIG. 4 shows underlying results displayed when clicking a row of the report;

FIG. 5 shows a Stored procedure depicting the relationship between a search engine and a stored procedure;

FIG. 6 shows a Stored procedure process part 1;

FIG. 7 shows a Stored procedure process part 2; and

FIG. 8 shows a Stored procedure process part 3.

### DESCRIPTION OF THE PREFERRED EMBODIMENTS

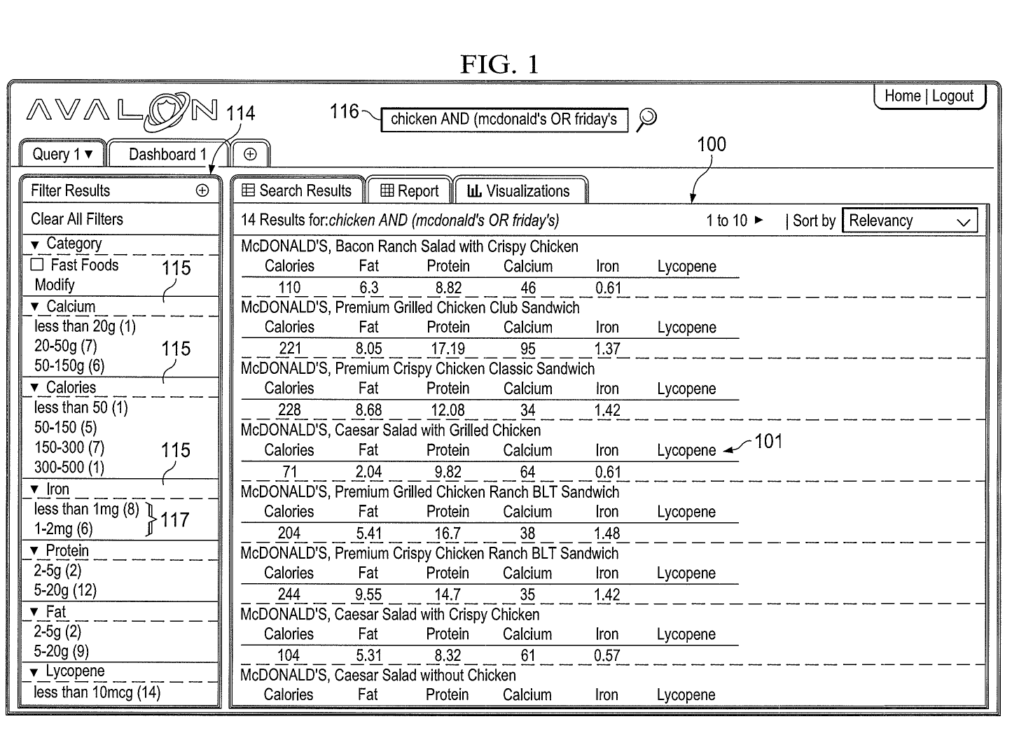

One embodiment of the present invention enables users to create reports on columns from records filtered by ad-hoc search queries. FIG. 1 shows at label 100 records matched by an ad-hoc query. FIG. 1 shows an example user interface, called a “faceted search application”, with user interface controls for a user to specify an ad-hoc search query by typing a Boolean query into the search box shown at label 116 and using facets shown at label 114 by selecting any of the facet values and counts on the left hand side such as those shown at label 117. The records shown at label 100 represent records matching the ad-hoc query users update via the text in the search box or via selected facets. The matched records each have columns such as those shown at label 101 which become the basis for users to create reports. The record columns correspond to the facet group headings shown at label 115.

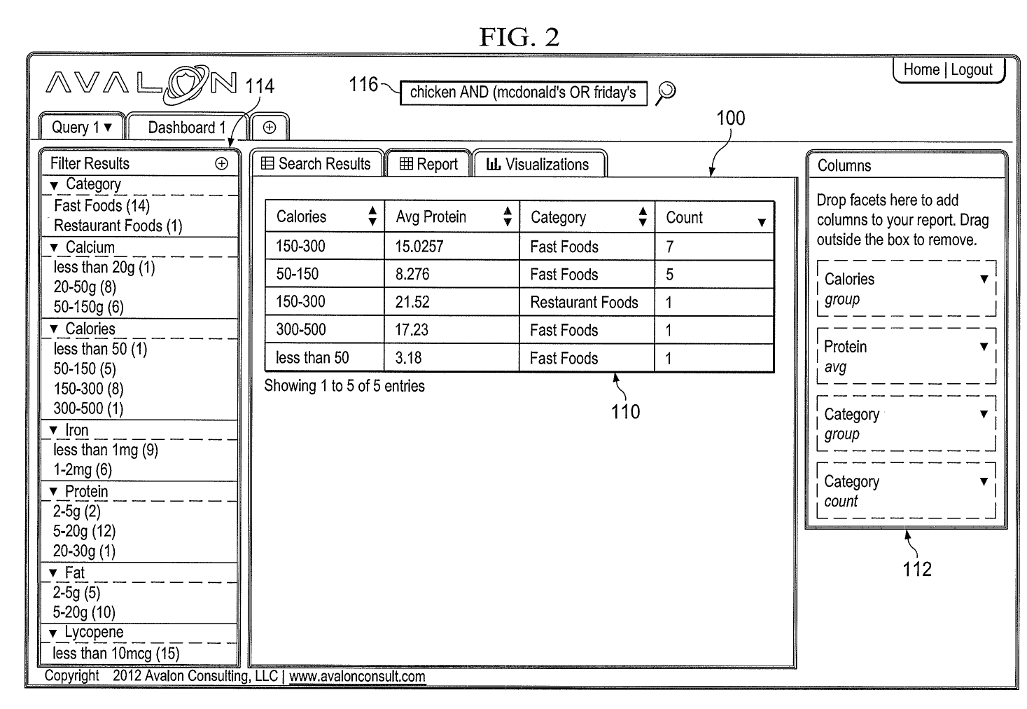

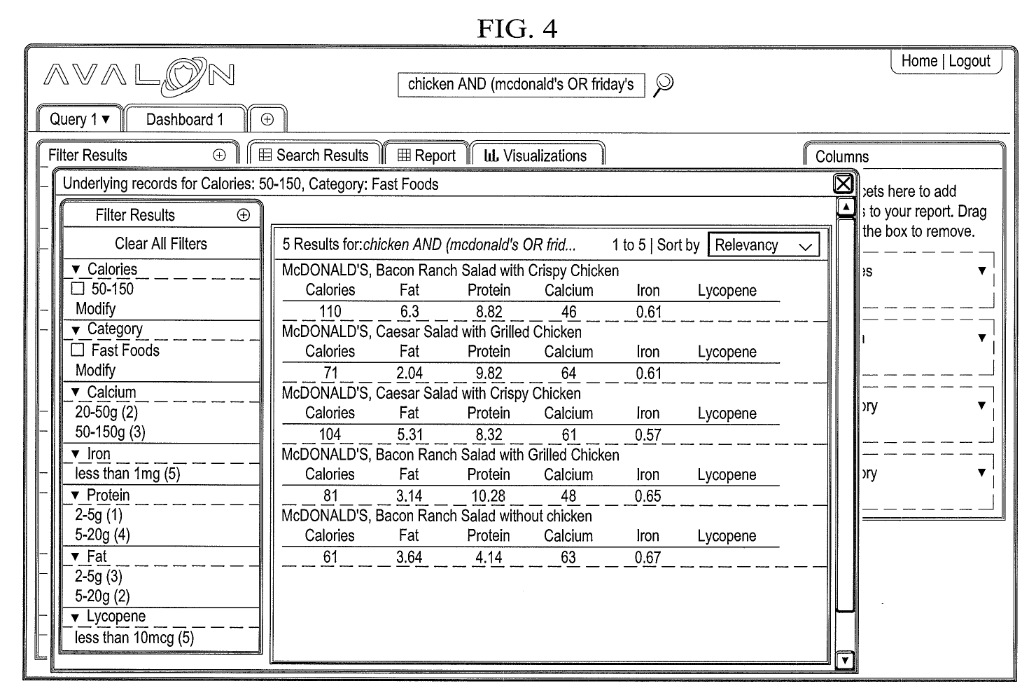

FIG. 2 shows at label 110 an example of a report created by a user selecting the columns shown at 112 for the report. While search engines have long offered facets, visualizations, and aggregations to summarize one or two columns at a time, the present invention achieves advantages by enabling users to select three or more columns and bringing this report firmly into the realm of powerful business intelligence applications, which offer excellent ways to analyze structured information. Additionally, the integration of search functionality such as ad-hoc queries, faceted search, and dynamic summaries brings this application well beyond the capabilities of classic business intelligence applications. While the report shows columns and rows of values for each column which summarize the underlying records, users may select a row to see the records which have columns containing the values displayed in that row (see FIG. 4). Just as in the search application, users narrow their data set using ad-hoc search queries defined through controls shown at labels 114 and 116. While such controls are commonly used for unstructured information analysis, this method shows how the same controls are used for structured information analysis (called “business intelligence”) or for unified analysis of unstructured and structured information (called “big data analytics”).

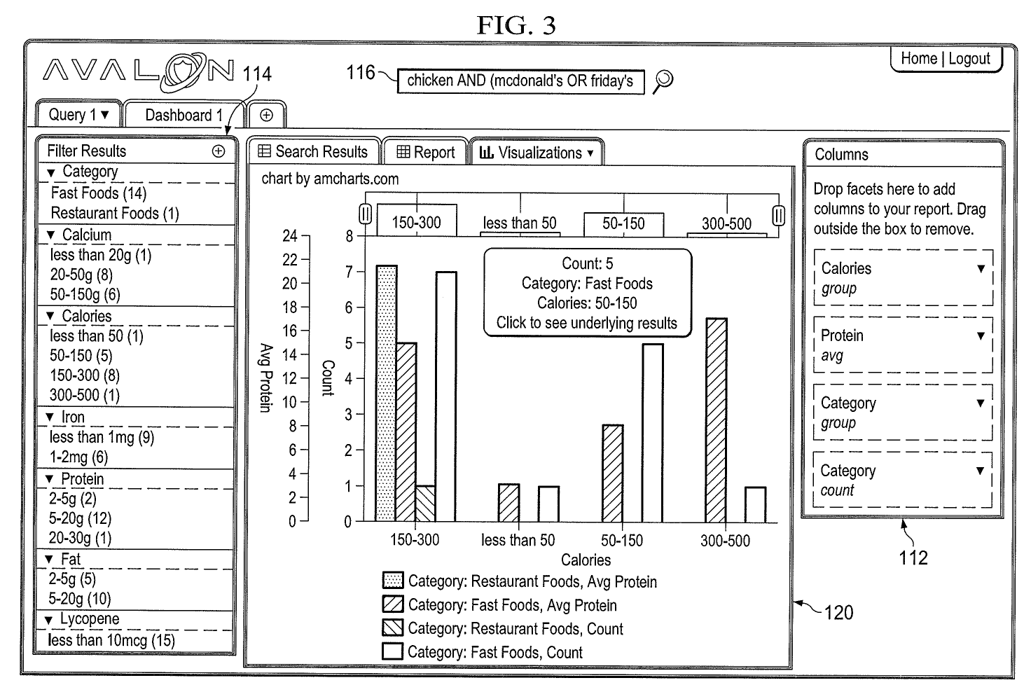

This method also advantageously enables users to create visualizations on more than two columns from records filtered by ad-hoc search queries, much like users create reports. FIG. 3 shows an example of a visualization at label 120, with the same search box at label 116, faceted search at label 114, and selected columns at label 112.

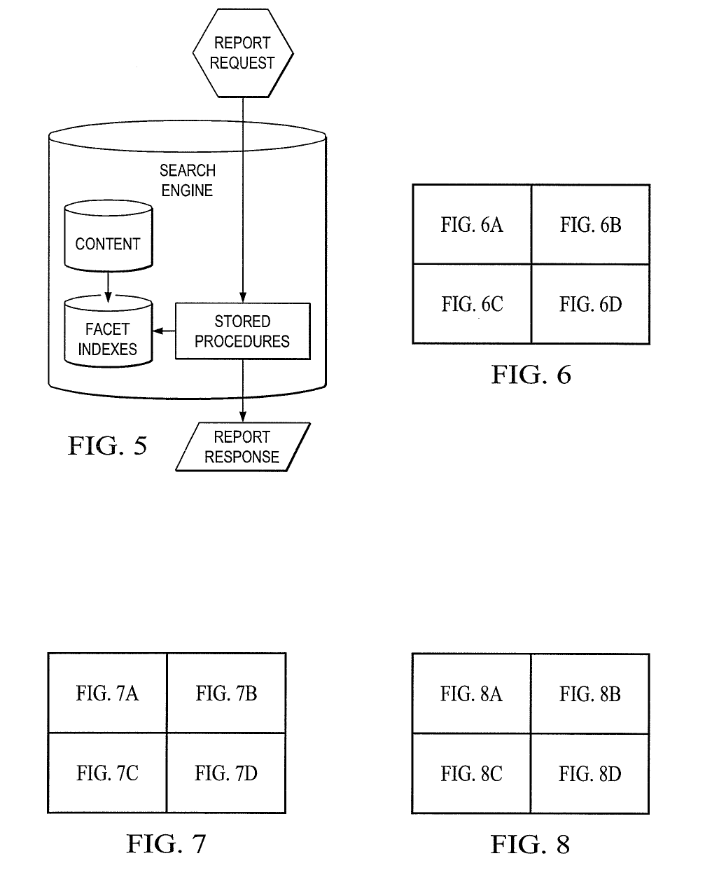

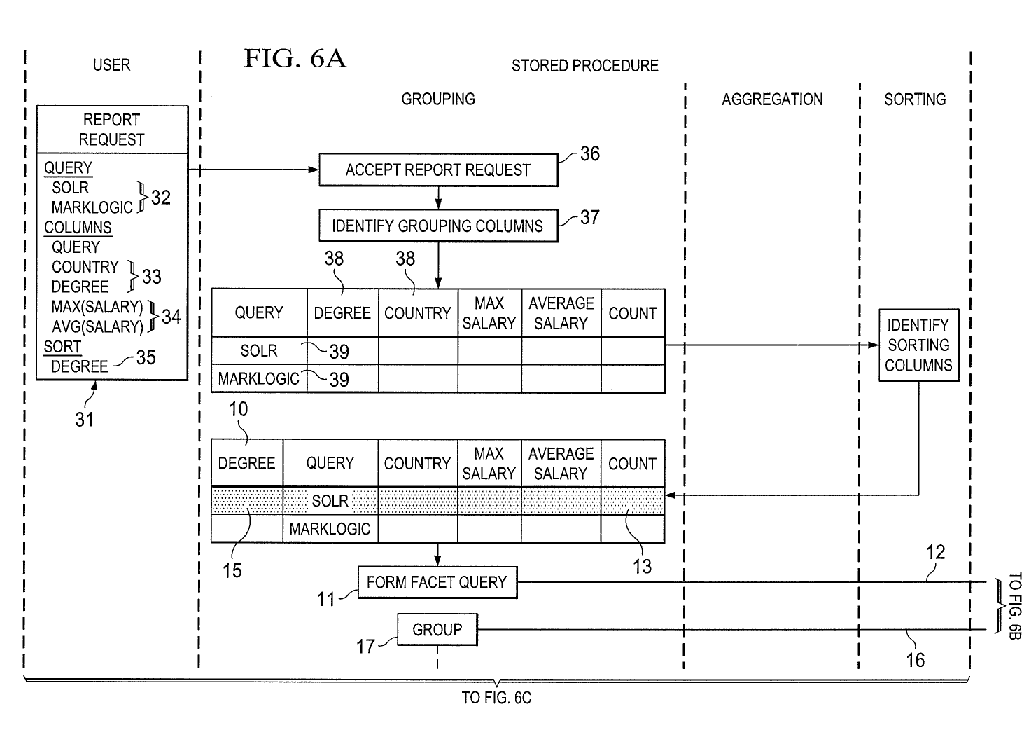

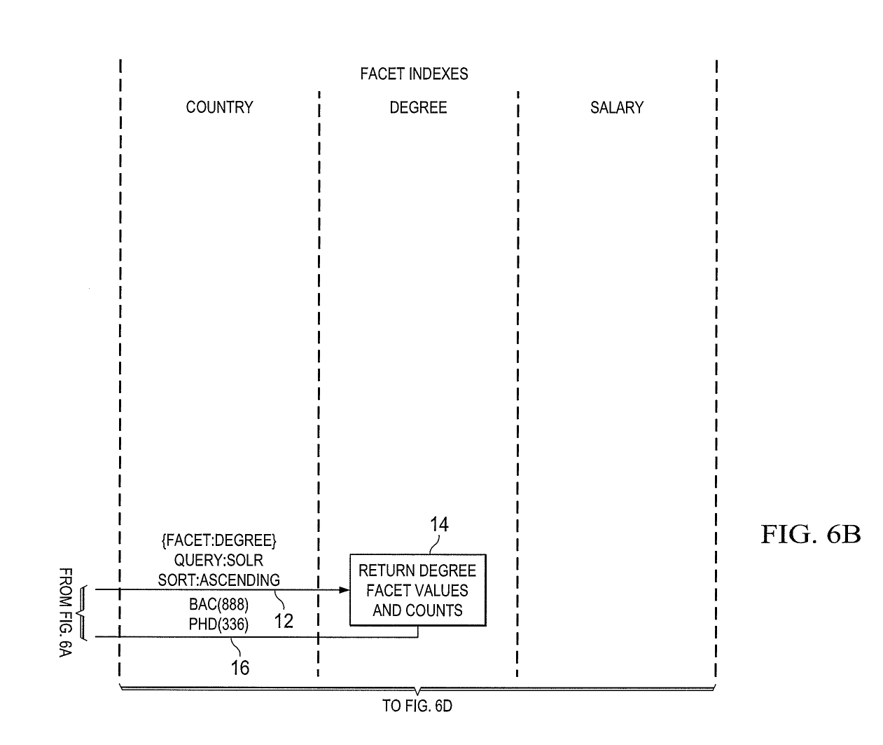

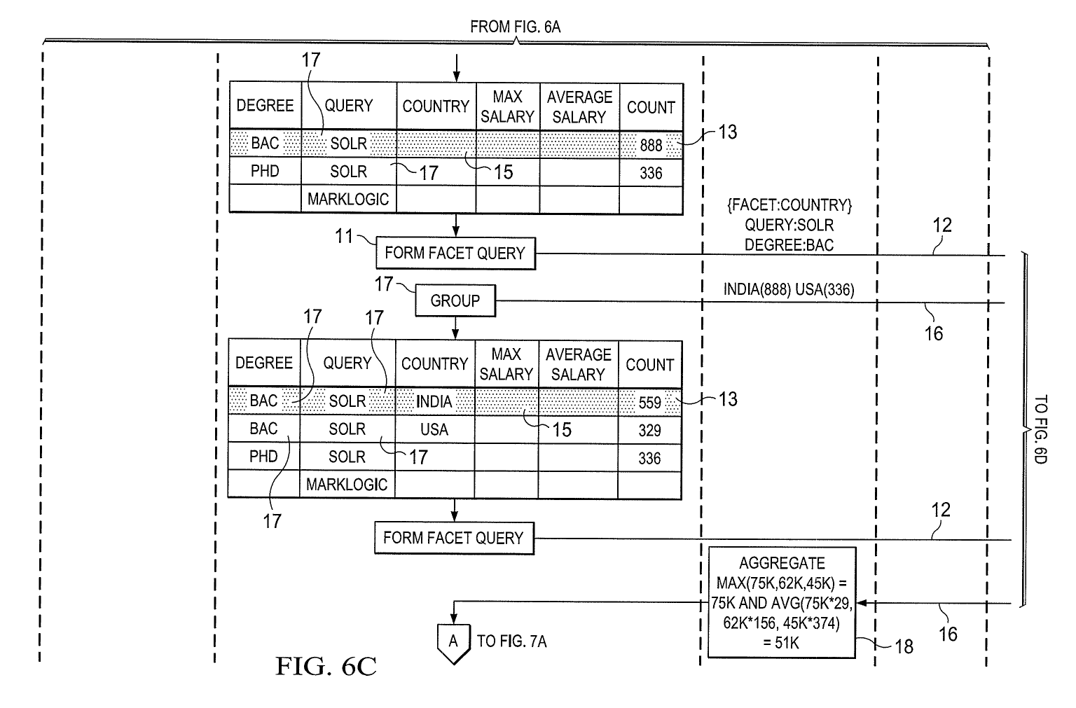

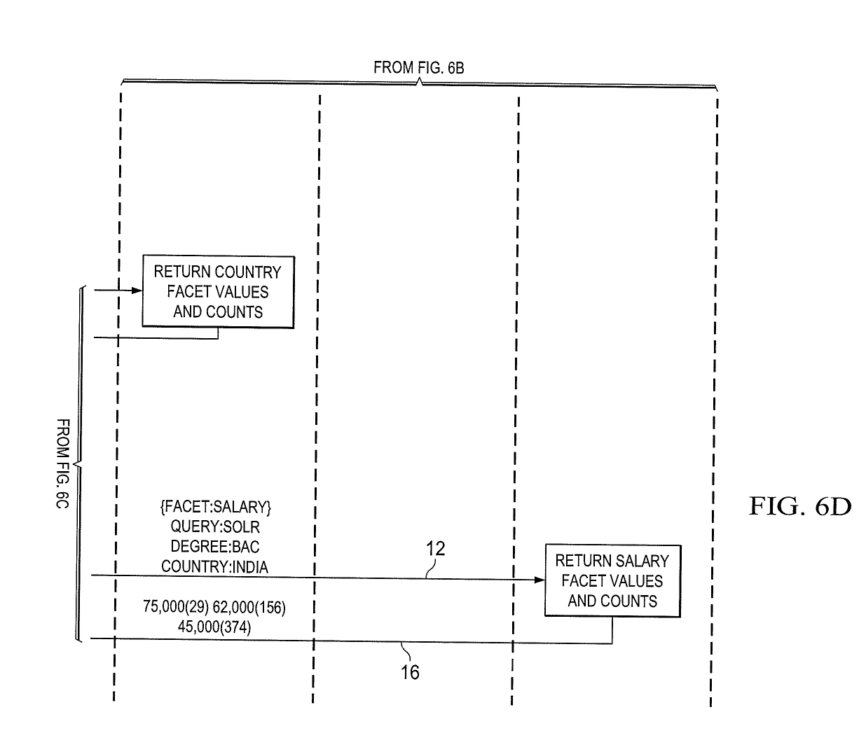

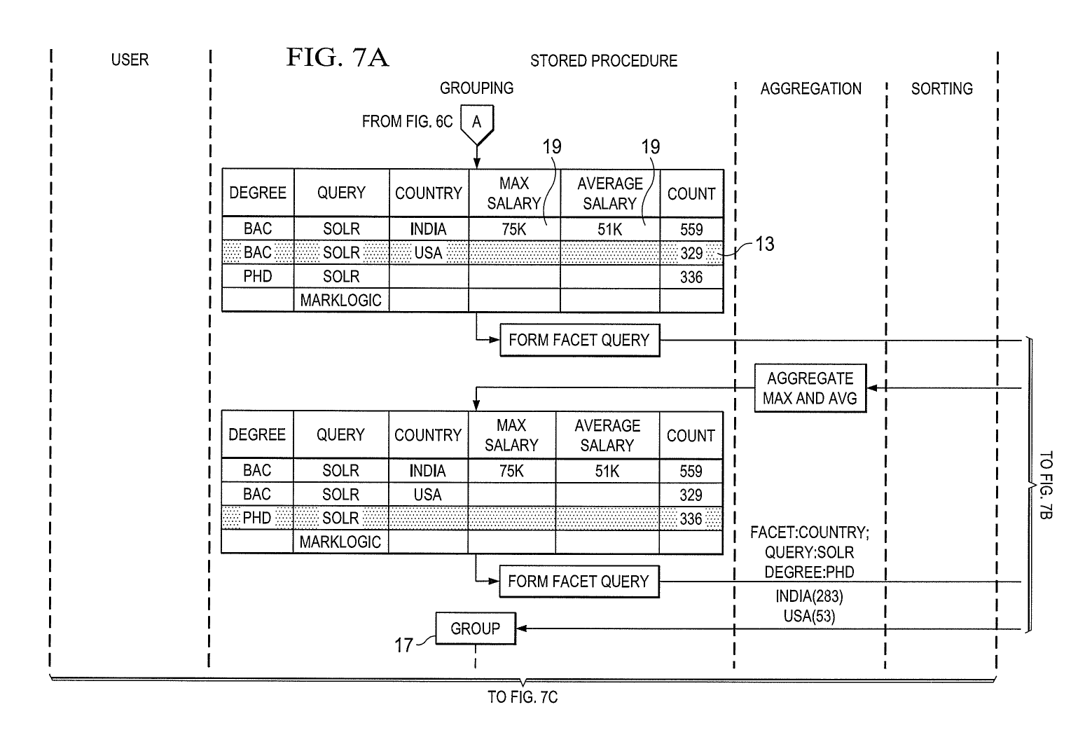

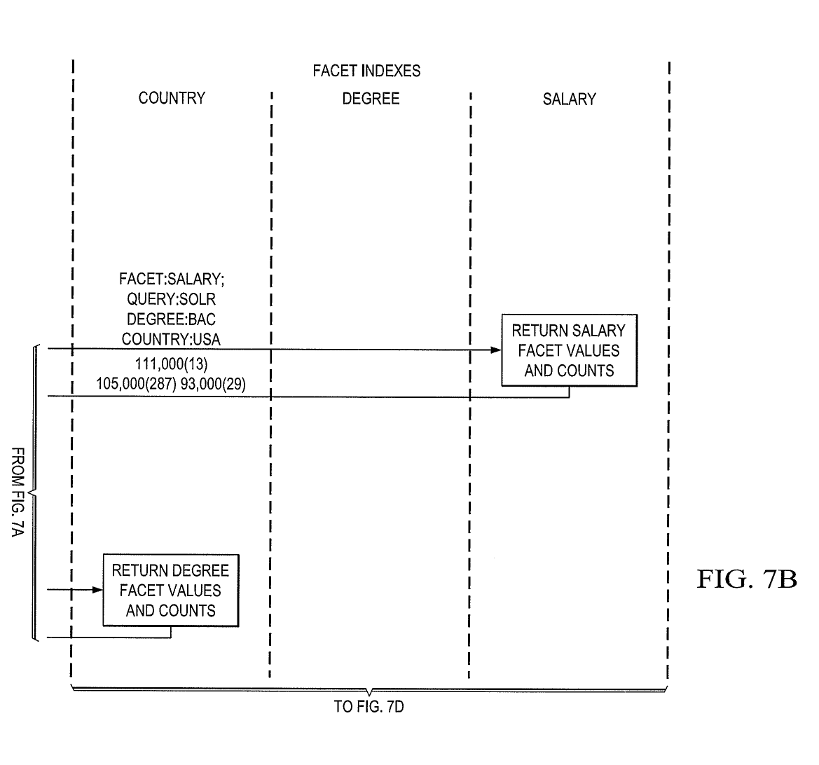

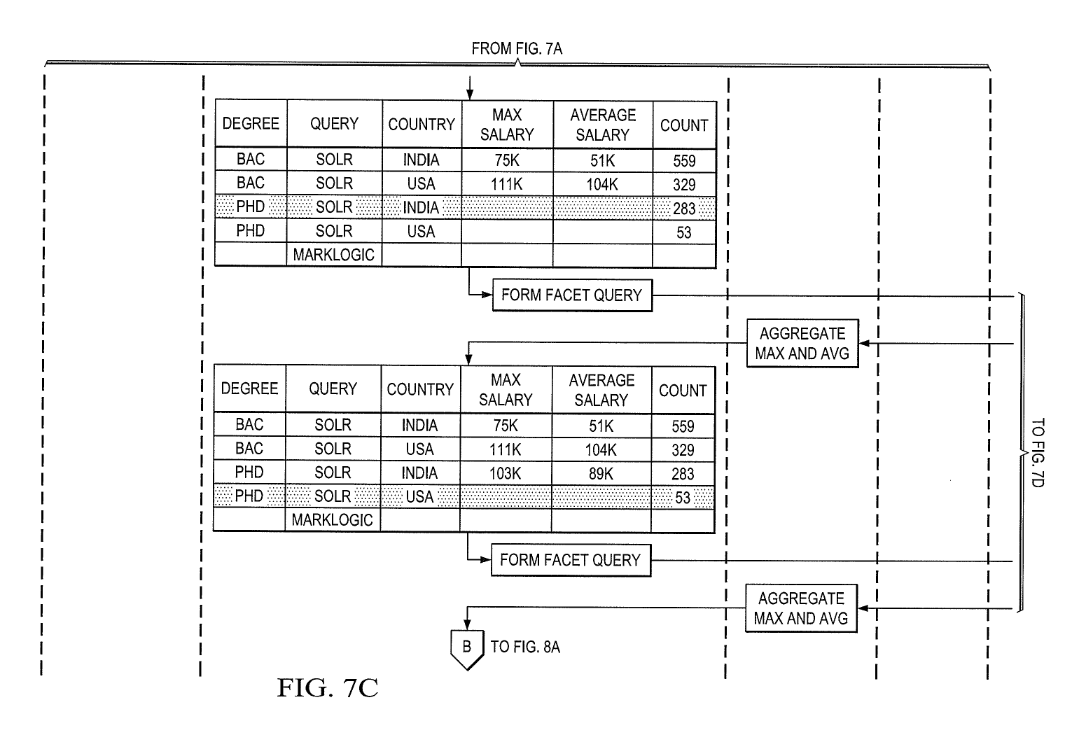

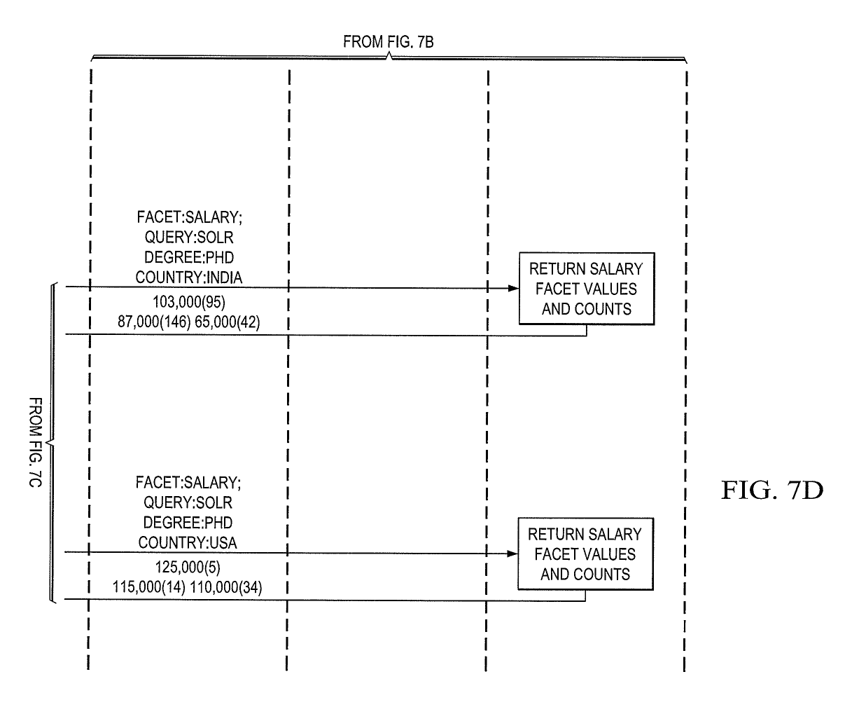

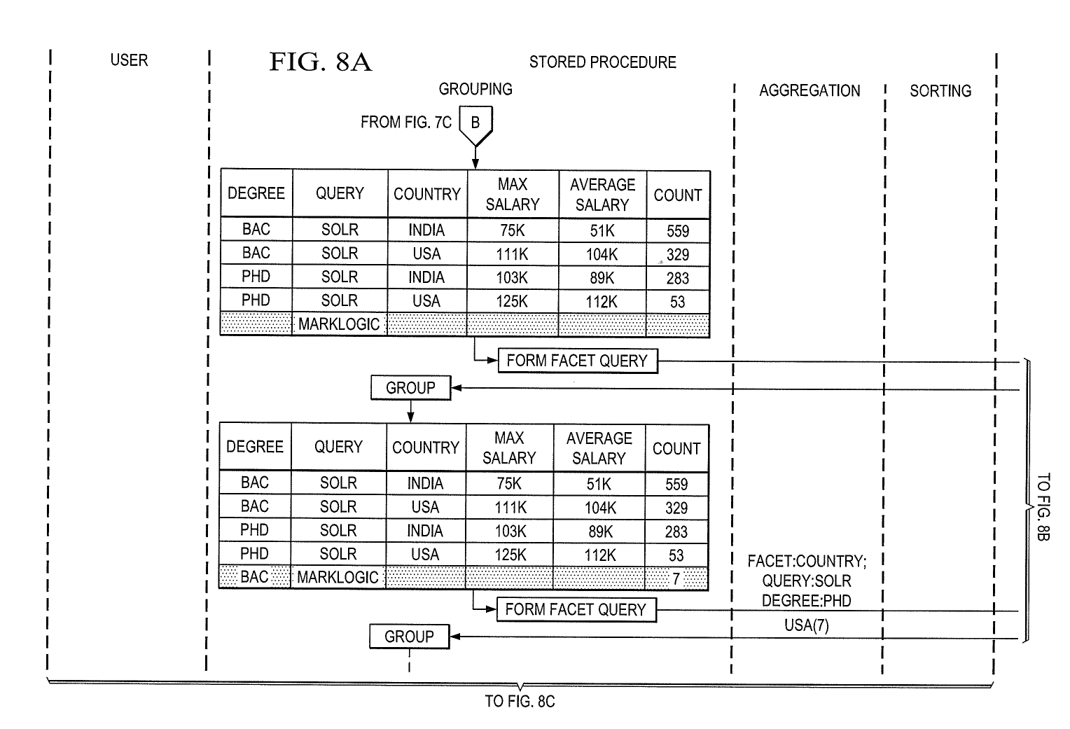

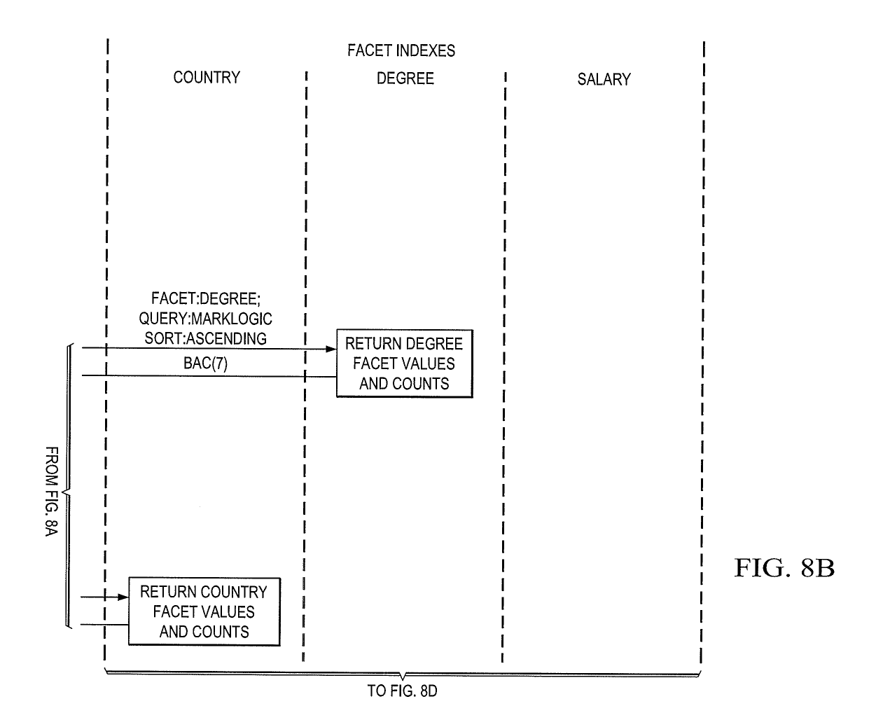

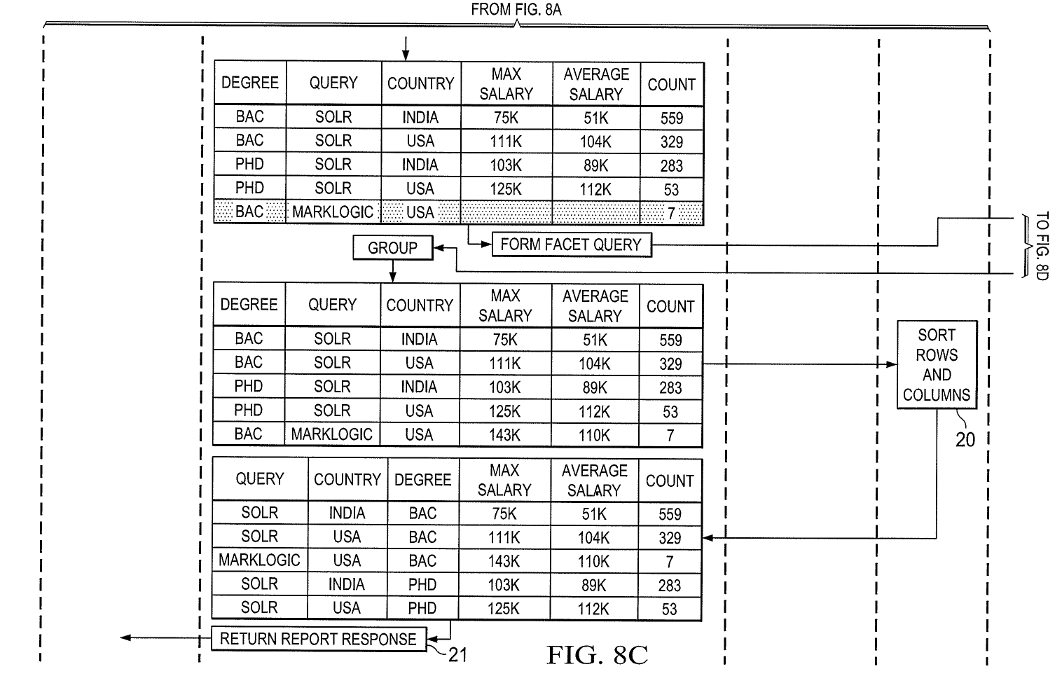

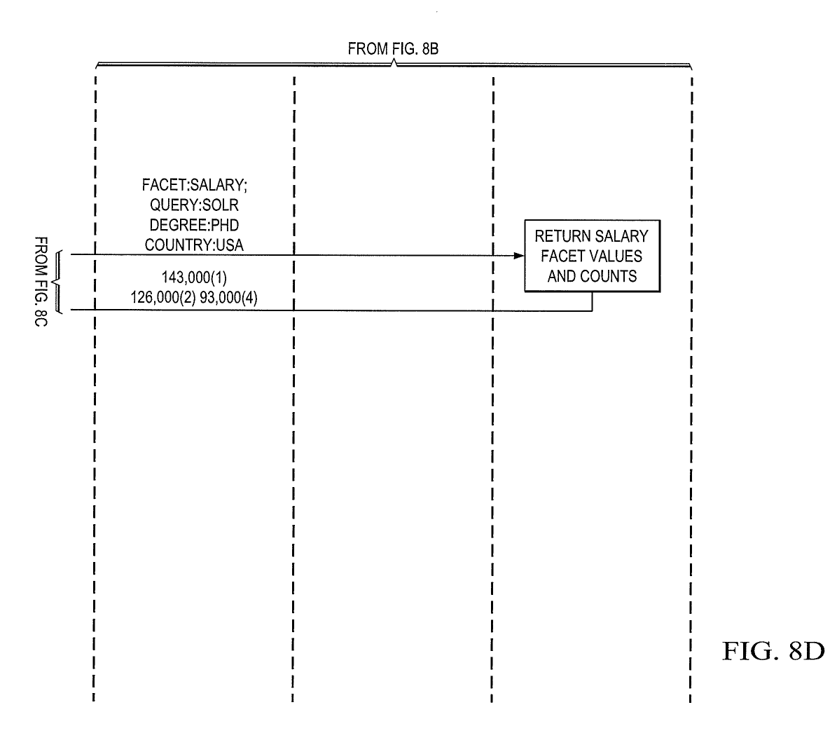

The examples shown at labels 100, 110, and 120 are made possible by a process detailed in FIGS. 6, 7, and 8. As shown in FIG. 5 this process comprises a set of instructions configured to be executed inside a search engine's memory space as a stored procedure as shown at label 130. This enables the stored procedure to run many queries against facet indexes with low latency and no inter-process communication overhead for an overall faster response time. Additionally, while memory is available and the user session is active, the stored procedure maintains a cache of reports in the search engine memory to speed responses to repeat requests or requests for additional pages of a report.

The process in FIG. 6 begins with a user interacting with an application which enables the user to chose options to define a report. The application translates the user's selected options into a report request shown at label 31. In this example the user is analyzing a set of resumes and this report request contains the following requirements:
1) two search term queries shown at 32, “solr” and “marklogic”, each of which will limit results to only the resumes containing a match for the search term
2) two grouping columns shown at 33, “country” and “degree”, which will be used to group facet values into report rows
3) one aggregation column shown at 34, “salary”, with two aggregation functions, “max” and “avg”, which will be used to aggregate facet values

The application then sends the report request to the stored procedure. FIG. 6 separates the stored procedure into three sub-processes:
1) grouping—the process of requesting facet values from the facet indexes and groping, or creating new rows by repeating the row values for each returned facet value
2) aggregation—using the aggregation function assigned to each column, processing the facet values according to the algorithm executed by the aggregation function
3) sorting—the processing required to ensure report rows are sorted according the sort columns specified in the report request

The stored procedure receives the report request 36 sent by the application, then identifies the grouping columns 37 since the rows of the report consist of all combinations of values from the grouping columns found in the data. In this example the two grouping columns, “country” and “degree”, are the second and third columns in the in-memory report ready to be populated 38.

When the report request includes multiple queries, as in 32, the stored procedure treats each similar to a value from a facet index query for a grouping column 39. Each query could contain any capability offered by the search engine for filtering results, including all kinds of text search and all kinds of field filtering. In this example the queries are simple text search term queries, “solr” and “marklogic”, so the stored procedure groups the rows by the set of resumes matching each search term. In this way the queries act very similar to values in grouping columns.

When the report request includes aggregation columns, as in 34, the stored procedure uses all values returned from the facet index query plus the count of underlying records for each value to calculate the correct aggregation value. Some aggregation functions perform numeric calculations, such as maximum or average as shown at 18. Other aggregation functions perform non-numeric processing, such as combining all values and counts into a string similar to the common textual display of facet as shown in FIG. 1 at 114.

When the report request includes sorting columns as shown at 35, it orders the sorting columns first as shown at 10 to prioritize processing of the data that will be displayed to the user after sorting. When report requests limit the number of rows returned, not all rows are processed—only the rows which will be displayed. By querying facet indexes for the sorting columns first, less queries are required to find enough rows to meet the specified limit, thereby improving response times. After the stored procedure has identified which columns are queries, which are grouping, which are aggregation, and which are sorting, it is ready to begin querying facet indexes as shown at 11.

The next row with missing values as shown at 13 is used to form a facet index query as shown at 11 to obtain the missing values. The facet index query targets the facet index corresponding to the next column in the row without a value as shown at 15. All values already in the row become filters in the query to the facet index as shown at 12, so the returned facet values and the count of underlying records for each value as shown at 16 will only include the underlying records appropriate for that row of the report. For grouping columns, each value returned by the facet index query is added as a row to the report, repeating the values from all other columns as shown at 17. For aggregation columns the values and counts returned by the facet index query are processed by the appropriate aggregation function as shown at 18, and the output of the function is added to the row as shown at 19. If multiple columns contain aggregations on the same facet index, all use the same facet values and counts without requiring additional facet index queries as shown at 18. This example has two aggregation columns using the salary facet index—one using the maximum (max) function and another using the average (avg) function as shown at 18. After grouping and aggregation functions complete, the process described in this paragraph is repeated until all values for each row are obtained. FIGS. 6-8 show all steps for a sample report request to fill all rows for the complete report response.

After the last row for the report has been populated, a final sorting step as shown at 20 is required to reset the columns to the order specified in the report request and to sort rows that could not be sorted by the facet index queries. If no sorting columns are specified, this step is skipped. If there is only one query in the report request and if sorting columns are all grouping columns, the sorting from facet index queries is adequate and no rows will be sorted in this step. See below for additional discussion of sorting aggregation columns.

After grouping, aggregation, and sorting logic is complete, any final processing is conducted then the report is returned to the end-user application as shown at 21. Final processing may include serializing the report into a format requested (for example JSON, XML, or CSV), formatting columns into a requested number format or date format, or calculating and returning a total count of underlying records.

To optimize speed of response, applications may specify a row limit. In this case a report may be returned when enough rows are obtained but before obtaining all possible rows. The user can then paginate, or request subsequent pages (or sets of rows) in the report. To support pagination a start row is specified with each report request. When total count of underlying results is required by the application, but a row limit is specified, the total count is estimated. Rows are cached in the stored procedure to optimize speed of response during pagination.

When a row limit is specified and an aggregation column is also the primary sorting column it is impossible to complete the sorting until all rows are obtained. In this case the application may still request the row limit to obtain a fast initial response with acknowledgement that the sorting will only be complete for the initial set of rows, not for all possible rows. Then the application may stream results by automatically requesting additional pages of rows and inserting them into the user display with sorting completed in the application. This allows the application to obtain the benefits of a fast initial response then rapidly obtaining the rest of the available rows in order to provide an accurate sorting of the data.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

### DEFINITIONS

ad-hoc query—A user-specified search query including a search query and filters.

aggregations—Summary operations performed on the values from a column of data such as average, minimum, maximum, count, count distinct, or facets. For simplicity, grouping is also considered an aggregation for the purpose of this method.

basic text query—Text which a search engine processes to return documents which match the text according to rules defined by the search engine. The most basic rule set accepts a string of characters, ignores word boundaries, and returns any document containing the string of characters from the query. A more optimized rule returns any documents containing any or all words in the query.

business intelligence report—A combination of data, aggregations, and visualizations to facilitate analysis of data for the purpose of making effective decisions based on the data.

categorization—A type of machine learning which uses sets of training documents and additional configuration settings to define categories against which new documents are compared. When new documents look similar enough to a category they are tagged as belonging to that category.

column—A clearly defined data field from documents of a similar type.

column index—An index or data structure built by a database or search engine and optimized for fast retrieval or aggregation of data from a column.

content extraction—When a set of documents follows a known pattern, the contents or fields and values of the documents are separated from the format of the documents. This exposes known content structures from documents otherwise considered unstructured.

entity extraction—Using controlled vocabularies together with patterns which depend on part-of-speech detection and other text analytics, “entity types” are defined. Any text from unstructured documents which matches an entity type is tagged, thus detecting structure inherent in the language of documents otherwise considered unstructured.

document—An unstructured record in a search engine. Similar to a row in a relational database, but allows for more complex structures.

document type—Documents of the same type contain enough similarity in their document structure that columns are reliably identified.

drag-n-drop—Used herein, drag-n-drop is a metaphor for any user experience simple enough for use by non-technical users and interactive enough to display complete and up-to-date results in real-time as the user interacts with the system.

facets—A list of columns and the values for each column. Usually shown as a summary or aggregation of search results, displaying only the values contained in documents which match the search query, and a count of how many documents match each value.

field index—A specialized index built by a search engine for the purpose of delivering summary information about values from the field or filtering results to only those matching certain values (or ranges of values) in the field. Unlike a normal search index which indexes tokens (e.g. words) from text, a field index indexes the entire value for the field, even if it contains multiple tokens. Documents in a search engine may have multiple fields indexed, similar to tables in relational database having multiple columns indexed.

facet index—Equivalent to a field index.

facet name—A name attached to the set of values returned from one facet index.

facet values—The list of values from one facet index which match the search query. Each facet value is commonly displayed with a number in parenthesis which matches the number of underlying results. In web interfaces, facet values are usually links. It is common that clicking a facet value will filter the search results to only those containing that facet value, thus reducing the number of results to the number displayed next to the facet value before the link was clicked.

faceted search—A.K.A. Faceted navigation, faceted metadata, guided navigation, categories, and many other names. Faceted search is considered by some the most important search innovation of the past decade. See facets.

faceted search experience—Any user experience (graphical user interface) which includes faceted search.

field—Equivalent to a column for the purposes of this discussion.

filter—Each filter includes a pattern, an operation, and a column. The search results which match a filter must have a value in the column which matches the pattern according to the rules defined by the operation. For facet value filters the operation is ‘equals’—so matching results have exactly that facet value in the corresponding facet index.

full-featured search—As users interact with search experiences they enjoy, they begin to expect other search experiences to incorporate the beneficial features. Thus as new features gain in popularity, the definition of full-featured evolves. Currently, the features commonly desired by users include facets, auto-complete, relevance ranking, sorting, dynamic summaries with hit highlighting, compact and informative result summaries, intuitive filtering controls, and search queries as described below.

grouping—Equivalent to the grouping operation of relational algebra or the GROUP BY clause of SQL. This grouping is referred to as co-occurrence of values in the documents in the search engine.

interactive—A user experience which empowers iterative analysis by responding quickly to each request the user submits. When responses are slow, users do not remain focused on their analysis and try far fewer request iterations. Modern search engines process most requests and return a complete response in less than one second, setting the bar by which other interactive tools are measured.

metadata—Equivalent to a column for the purposes of this discussion.

results—Summary information about documents which match a search query.

row—A record in a relational database usually composed of one value for each column. Similar to a document in an search engine, but allows only simpler structures.

record—Equivalent to a document for the purposes of this discussion.

request—A computer-readable configuration for the instructions to generate an appropriate response.

report request—A computer-readable request for a report response. It is often generated by a report building application. It includes the columns desired, with the understanding that each row of the report will be grouped or aggregated by the values in each column. It includes any ad-hoc queries to restrict the data included in the report response. It specifies which columns to sort the report by and any start row or limit to number of rows.

report—A representation of data values organized as columns and rows which match a report request. In the preferred embodiment reports are presented with report building features so the user can interactively change the sorting and other aspects of the report request. Users can export a report to various human readable formats such as PDF or HTML. Users or applications download or access reports as a web service in computer-readable formats such as CSV, XML, or JSON. A report provides the data on which visualizations are built.

report building—While faceted search experiences inherently provide some business intelligence since they summarize various facets of the result set, traditional business intelligence tools offer important additional features in the form of a report builder. A report builder is an interactive user experience which allows users to easily create a report request including the key features of adding as many columns as desired to the report and choosing for each column whether to group or aggregate the report by the values in that column. The best report builders allow users to see their report update live as the user adjusts the report request.

response—The complete computer-readable answer by the instructions to a request.

report response—The complete answer by the instructions to a report request from the user, usually including results and facets.

response time or response speed—The time taken by the instructions to provide the response. It starts at the moment the request is first received and ends when the response is fully transmitted.

search and analytics request—An ad-hoc query plus analytics operations from the set of grouping, aggregation functions, predictive functions, or joins. Similar to an SQL SELECT query, but with all the search functionality of ad-hoc queries as described in these definitions.

search engine—Software which enables interactive analysis of unstructured, semi-structured, and structured data by returning results and facets which match ad-hoc queries. While users benefit from the features offered by full-featured modern search engines, this method requires only basic text query and faceted search capabilities.

search query—A textual query to a search engine including keyword queries, substring queries, Boolean queries, natural language queries, wildcard queries, exact phrases, pattern matching, regular expressions, fuzzy queries, soundex queries, and conceptual queries. All textual queries are parsed into terms and each term is configured to match with respect for or ignorance of punctuation, case, word stems or lemmas, synonyms, stop words, diacritics, word separators, and word joiners.

visualization—A visual way of summarizing information using shapes, colors, and text. Visualizations facilitate understanding and analysis of information. Some examples are charts, graphs, maps, and infographics.

1. A computer implemented method for using search engine facet indexes when processing search and analytics requests which include configurations which typically require a relational database, the method comprising:
using a search engine which includes a plurality of facet indexes;
executing instructions configured to query the search engine and handle requests which typically require a relational database and to access at least three said facet indexes during a request, and;
generate and return a response.

2. The method of claim 1, wherein an optimized relationship exists between the instructions and the search engine.

3. The method of claim 2, wherein the instructions are configured to run a plurality of said queries rapidly.

4. The method of claim 2, wherein the instructions are configured to be executed in a memory space of the search engine.

5. The method of claim 1, wherein the instructions are configured to provide grouping and aggregating functions.

6. The method of claim 5, wherein the instructions are configured to accept a report request which includes a list of columns and return a report response.

7. The method of claim 6, wherein the columns are associated with an optimized configuration comprising either a facet index or cache.

8. The method of claim 5, further comprising specifying aggregation functions (such as average, sum, min, max, mean, standard deviation) for any number of columns in the report request.

9. The method of claim 5, further comprising specifying user-defined functions for any number of columns in the report request.

10. The method of claim 5, further comprising specifying sorting options for any number of columns in the report request.

11. The method of claim 5, further comprising specifying calculation or formatting options for any number of columns in the report request.

12. The method of claim 1, wherein the instructions are configured to pass thru result set filtering capabilities offered by the search engine, the filtering capabilities selected from the group of: keyword, phrase, stemming, boolean, field value matching, and geo-spatial.

13. The method of claim 1, wherein the instructions are configured to generate the response including facet values.

14. The method of claim 1, further providing an application user interface configured to allow users to adjust the details of the request.

15. The method of claim 14, wherein the application user interface includes a report builder.

16. The method of claim 1, wherein the request includes a requirement to filter data based on an ad-hoc query.

17. The method of claim 1, wherein the request includes an option to specify a limit to a number of rows of data and a starting row.

18. The method of claim 17, wherein the instructions include an application configured to allow users to paginate through pages of rows in the response.

19. The method of claim 18, wherein the application sends a new request to the instructions for each said page, enabling faster response times for each said page than are possible for the response including all rows.

20. The method of claim 18, wherein the instructions are configured to employ caching techniques.

21. The method of claim 1, wherein the search engine is configured to employ caching techniques.

22. The method of claim 19, wherein the application sends a request with a sorting requirement on an aggregation column such that response speed is increased by applying sorting only for results in said pages.

23. The method of claim 22 wherein the application continues to communicate with the instructions until enough rows are displayed to comprise a complete said report.

24. The method of claim 6, wherein the instructions are configured to provide a count of a total number of rows in the report response.

25. The method of claim 6, wherein the instructions are configured to provide an estimate of a total number of rows in the report response.

26. The method of claim 14, wherein facets are displayed in the application user interface to summarize attributes and values of documents which match the request.

27. The method of claim 26, wherein the request includes an ad-hoc query and the facets are filtered by the ad-hoc query.

28. The method of claim 26, wherein users may select a facet value or many facet values to add a filter to the request.

29. The method of claim 16, wherein a search box is included in the application user interface that allows users to specify or adjust a text search aspect of an ad-hoc query.

30. The method of claim 6, wherein the report request configures the instructions to render a visualization or multiple visualizations of the report response.
